(19) United States
(12) Patent Application Publication
(10) Pub. No.: US 2017/0175234 A1
(43) Pub. Date: Jun. 22, 2017

(54) METAL COATED HEAVY METAL POWDER FOR ADDITIVE MANUFACTURING OF HEAVY METAL PARTS

(71) Applicant: Raytheon Company, Waltham, MA (US)

(72) Inventors: Gaston P. Jennett, Tucson, AZ (US); Robert P. Johnson, Tucson, AZ (US); Dmitry V. Knyazev, Tucson, AZ (US); Richard G. Ames, Tucson, AZ (US)

(21) Appl. No.: 14/973,788

(22) Filed: Dec. 18, 2015

(51) Int. Cl. C22C 30/00; B22F 7/06; B23K 15/00; B22F 3/105; B33Y 10/00; B33Y 80/00

(52) U.S. Cl. CPC C22C 30/00; B33Y 10/00; B33Y 80/00; B23K 15/0086; B23K 15/0093; B22F 3/1055; B22F 7/06; B23K 2203/18

(57) ABSTRACT

A heavy metal part and method of manufacturing includes a dense alloy or a metallic composite consisting of a plurality of dense metal particles formed of a first metal and a melted metal matrix that is a continuous phase of the first metal and a second metal having a lesser density than the first metal. The metal particles are a discrete phase within the continuous phase and the heavy metal part is formed by an additive manufacturing process of a powder feedstock comprising the metal particles coated with the second metal.

### FIELD OF THE INVENTION

The invention relates to heavy metal parts, and more particularly to a method for manufacturing heavy metal parts where the final metal composition relies on the use of a very dense metal or metal alloy.

### DESCRIPTION OF THE RELATED ART

Heavy metal parts find a variety of uses that require high mass density, such as in absorption or blocking of radiation. There are various applications that may have adverse conditions. Examples of heavy metal parts used in adverse conditions are high impact tooling, warhead fragments, or other penetration projectiles. In the case of a warhead or ballistic penetrator, the shape, size, and material composition are selected according to functional considerations, including penetration, blast, and fragmentation performance. Other functional considerations include facilitating delivery through the air and integrating the warhead into other assemblies, such as missile systems.

Heavy metal alloys are generally based on a dense pure metal or a metal alloy containing elements such as tantalum, tungsten, rhenium, or osmium, due to their relatively high density compared to other metallic elements. Lighter metallic elements are used to form a single phase alloy with the dense metal or form a metal matrix that binds together undissolved particles of the dense metal or metal alloy. These single phase alloys or multiple phase metallic composites have typically been formed by the use of powder metallurgy. The constituent metal powders are mixed, compacted, and then melted in a furnace to form a melt, an intermediate shape, or final shape.

Conventional heavy metal parts manufacturing methods include: casting, forging, machining, welding, and other subtractive manufacturing methods to construct core components. However, conventional manufacturing methods are deficient in forming a heavy metal alloy part having a complex shape in addition to a desirable material composition. High density metal constituents tend to have very high melting points and also may not be compatible with additive manufacturing processes in that the dense metals may not completely alloy with other metals in the formation of a heavy metal part.

### SUMMARY OF THE INVENTION

According to an aspect of the invention, a heavy metal part includes a plurality of metal particles formed of a first metal and a metal matrix that is a continuous phase of a mixture of the first metal and a second metal having a lesser density than the first metal. Where the dense metal particles are not completely dissolved, they will exist as a discrete phase within the metal matrix and the heavy metal part is formed by an additive manufacturing process of a powder feedstock comprising the metal particles coated with the second metal.

The heavy metal part may be formed of an alloy or metallic composite of the first metal and the second metal.

The second metal may have a melting point lower than that of the first metal. The second metal may solder to the first metal.

The additive manufacturing process may include one of direct metal laser sintering, electron beam melting, and micro-induction sintering.

The metal matrix may be composed of a greater weight percent of the second metal than the first metal.

The first metal may have a solubility in the metal matrix between 30 and 35 percent.

The first metal may have a density greater than 16 g/cm³ and a melting point higher than 6000 degrees Fahrenheit.

The first metal may be tungsten.

The second metal may be nickel.

The metal matrix may include a third metal. The third metal may be cobalt.

According to another aspect of the invention, a method for manufacturing a heavy metal part includes: melting a portion of a powder feedstock comprising a plurality of pure metal particles formed of a first metal that are coated in a second metal, to form a layer. The layer is comprised of a metal matrix that is a continuous phase of a mixture of the first metal and the second metal, and the metal particles are a discrete phase within the metal matrix. The method further includes welding the layer to another formed layer to grow the heavy metal part.

The method may include heat treating the heavy metal part to optimize specific material properties including tensile strength and ductility.

The method may further include direct metal laser sintering the layer.

The method may further include electron beam melting the layer.

The method may still further include micro-induction sintering the layer.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a schematic drawing of a metal particle in accordance with an exemplary embodiment of the present invention.

FIG. 2 is a schematic drawing of a plurality of the metal particles of FIG. 1.

FIG. 3 is a schematic drawing of a metal matrix having a continuous phase and a discrete phase in accordance with an exemplary embodiment of the present invention.

FIG. 4 is a schematic drawing of a metal particle in accordance with a second exemplary embodiment of the present invention.

FIG. 5 is a schematic drawing of a system for manufacturing a heavy metal alloy.

### DETAILED DESCRIPTION

A heavy metal part according to the present application may include a plurality of metal particles formed of a first metal and a metal matrix that is a continuous phase of a mixture of the first metal and a second metal. Where the dense metal particles do not completely dissolve on melting of the second metal, the dense metal particles are a discrete phase within the metal matrix. The heavy metal part is formed by an additive manufacturing process of a powder feedstock comprising the dense metal particles coated with the second metal. The heavy metal part will generally have pockets of dense metal particles that have partially dissolved into the second metal to form the continuous phase.

The ratio of the dense metal and the second metal in the coating is controlled such that each coated particle represents the ultimate composition of the heavy metal alloy or composite. The heavy metal part according to the present application retains the optimal material properties of the heavy metal alloy or composite, including ductility and density properties. The resultant powder is a feedstock that makes the manufacture of heavy metal parts by additive manufacturing techniques possible. The resultant powder is advantageous compared with that used in manufacturing conventional heavy metal parts, where the high density metal constituents tend to have very high melting points and are not compatible with additive manufacturing processes. Such dense metals may not completely alloy with other metals in the formation of the heavy metal part.

The coated powder may also be used to improve the handling properties of the powder feedstock in traditional powder metallurgy. The required ingredients will not separate by density on handling.

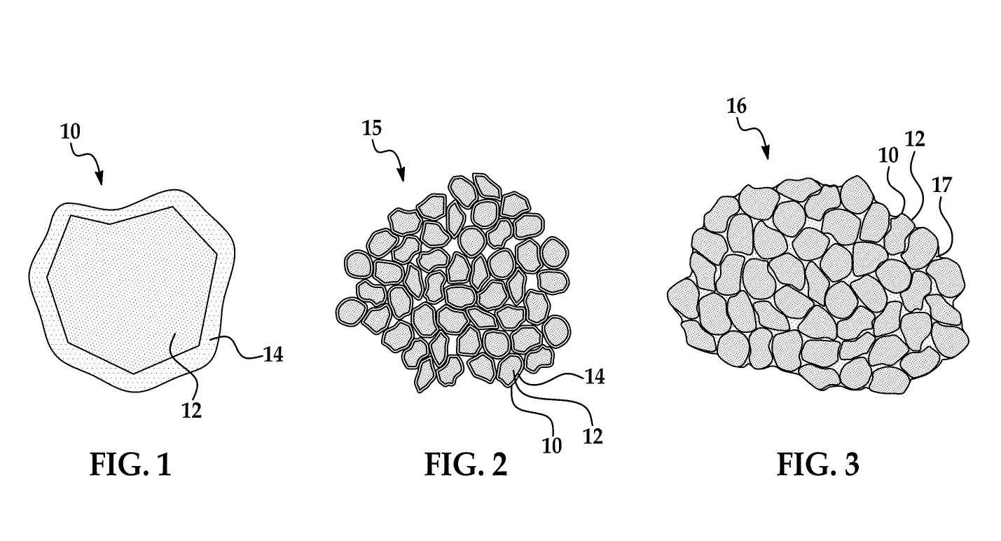

FIG. 1 is a schematic drawing of a metal particle 10 and FIG. 2 is a schematic drawing of a plurality of the metal particles 10. The metal particle 10 is formed of a dense metal particle 12 of a first metal that has a coating layer 14 formed of a pure second metal. The plurality of coated particles 10 are compacted together to form a powder feedstock 15. The first metal is soluble or partially soluble in the second metal and the second metal may have a material hardness that is lower than that of the first metal. The second metal may have a density that is less than that of the first metal.

FIG. 3 is a schematic drawing of a metal matrix 16 formed from the powder feedstock 15. The heavy metal part is formed of the melted metal matrix 16 and is formed by an additive manufacturing process of the powder feedstock 15. In the metal matrix 16 formed by the additive manufacturing process, the metal particles 10 are heated such that the dense particles 12 dissolve or partially dissolve in the molten coating 14 to form a continuous phase 17 of the first metal and the second metal. The undissolved portions of the dense particles 12 are maintained within the continuous phase 17 such that the metal matrix 16 contains pockets of the dense particles 12. The metal matrix 16 may be colloidal such that dense particles 12 are dispersed throughout the metal matrix 16. The second metal is the primary matrix constituent and would generally have a lower melting point than the dense metal 12. The first metal may have a density greater than 16 g/cm³ and a melting point higher than 6000 degrees Fahrenheit.

The metal matrix 16 may be composed of 30 to 40 weight percent of the first metal and 60 to 70 weight percent of the second metal. The metal matrix 16 may be composed of 35 weight percent of the first metal and 65 weight percent of the second metal.

In an exemplary particle 10, the first metal may be tungsten and the particle 12 is a pure Tungsten particle 12. The second metal may be Nickel and the coating layer 14 may be a pure nickel coating 14. Nickel has a much lower melting point than tungsten and acts as a solvent to the tungsten. The first metal may have a solubility in the second metal between 30% and 40%. Nickel can dissolve around 35% tungsten, by weight. The thickness of the nickel coating would be controlled to achieve the desired ratio of tungsten to nickel. This controls the material properties of the resultant alloy or metal composite. Similar binary systems are possible with other dense metal particles 12.

The feedstock powder 15 will consist of a variety of coated particle sizes. The particle size distribution is engineered to achieve a maximal packing density before the heating and fusing of the additive manufacturing or powder metallurgy processes. The mean particle size of the distribution is dependent upon the requirements of the manufacturing technique. Each of the tungsten particles may have a diameter between 90 and 110 microns. The thickness of the coating will be different for different size particles 12 so as to maintain the alloy recipe in each particle 10.

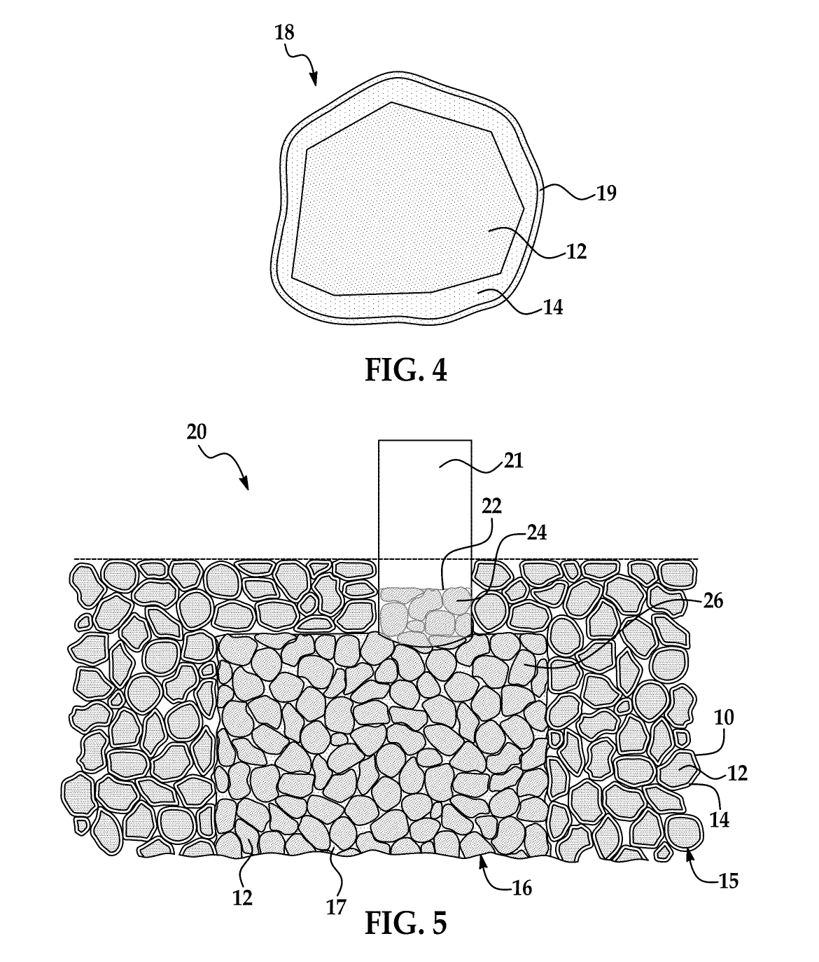

FIG. 4 depicts a feedstock particle 18 that consists of a core dense metal particle with two pure metal coating layers 14 and 19. The addition of coating layers of pure metals permits adding additional metals to the resultant alloy or metallic composite. The number of pure metal coatings is not limited to two and more complex alloys are possible through additional layers. In the case of additive manufacture, all of the coated layers must be within the melt capability of the process.

In an exemplary particle 28, a second layer 18 is added to the aforementioned tungsten and nickel system. An embodiment may include Iron as the second coating layer 19 to reduce the manufacturing cost of the heavy metal alloy. Still another embodiment may include copper as the second coating layer 19, to increase electrical and thermal conductivity of the heavy metal alloy. Yet another embodiment may be to add a strategic amount of cobalt as the second coating layer 19 to increase the solubility of tungsten in the metal matrix 17.

FIG. 5 is a schematic drawing of a system 20 for additively manufacturing the heavy metal part. The additive manufacturing process may include a powder-based additive manufacturing process. The process may include one of a direct metal laser sintering (DMLS), electron beam melting (EBM), and micro-induction sintering. The exemplary system 20 may include a laser for sintering, an electron beam 21 for melting, or another energy source for heating the powder feedstock 15. The powder feedstock 15 to be heated is formed of the plurality of dense metal particles 12 coated in the second metal and compacted together. In a DMLS process, the powder feedstock 15 may be used in a DMLS machine that is currently used to print stainless steel or cobalt-chrome, or any suitable DMLS machine. In an EBM process, the powder feedstock 15 may be used in an EBM machine using a high power electron beam managed by electromagnetic coils located in a vacuum.

Using either the DMLS or EBM process, the powder feedstock 15 is heated such that a surface 22 of a portion 24 of the powder feedstock 15 is melted to form a layer of the melted metal matrix 16. When heated, the pure metal particles 12 are dissolved or partially dissolved into the molten coating 14 to form the layer having a continuous phase 17 formed of the first metal and second metal, and pockets of the pure first metal particles 12 dispersed throughout the continuous phase 17. In the DMLS process, the formed layer may be between 20 and 50 microns. In the EBM process, the formed layer may be between 20 and 200 microns.

In an exemplary embodiment, the feedstock 15 formed of nickel coated tungsten particles initially may be heated at a temperature between 2500 and 3500 degrees Fahrenheit. The melting point of nickel is about 2651 degrees Fahrenheit and the melting point of tungsten is about 6192 degrees Fahrenheit, allowing the tungsten particles to dissolve in the molten nickel. In this example, it is not necessary to heat the feedstock powder 15 to above 6200 degrees Fahrenheit to melt the tungsten. The dissolution of the tungsten into the nickel forms the continuous phase 17 that is the metal matrix 16. The portions of the pure tungsten particles 12 that remain undissolved are maintained as a discrete phase within the metal matrix 16, and are dispersed throughout the continuous phase 17. The temperature used for heating the powder feedstock 15 may be dependent on the material of the powder feedstock 15 and the heating of the powder feedstock 15 may be controlled such that the time and energy used by either the DMLS machine or EBM machine may be modified.

After the layer is formed, it is welded to another previously formed layer to grow the heavy metal part. In the DMLS process, a 200-400 watt laser may be used to fuse the layers together at specific points. In the EBM process, a 2000-3000 watt electron beam may be used to fuse the layers together. In either the DMLS process of the EBM process, portions of the powder feedstock 15 are continuously heated to form new layers. The new layers are welded to the previously formed and welded layers to grow the heavy metal part in a layer-by-layer process. Once the heavy metal part has been formed, the finished part may further be heat-treated, or annealed, to optimize specific material properties such as tensile strength or ductility.

Heavy metal parts, and more specifically, tungsten heavy alloys, formed of the manufacturing process according to the present application are advantageous over previously used heavy metal parts. Additive manufacturing of heavy metal parts allows for parts that have geometries and structures that were not previously available from traditional subtractive manufacturing processes. Also, the packaging of the entire alloy composition in every feedstock particle ensures a more uniform part as the constituent metal powders cannot become unmixed with handling.

Typical heavy metal alloys have densities of around 12 g/cm³, whereas the exemplary finished metal matrix 16 of the heavy metal part may be controlled and have densities between 11 g/cm³ and 19 g/cm³. The density of the metal matrix 16 may be 16 g/cm³.

An additional advantage is that forming a powder feedstock containing the coated particles allows the powders that are not consumed during the additive manufacturing process to be recovered and reused. Conventional mixed powders of different metals may not be similarly recycled. Still another advantage is the composition of tungsten and nickel allows the material in the melted metal matrix to stay together in adverse conditions, such as in high impact or dynamic load applications. This is particularly advantageous compared with a part made of pure Tungsten that will shatter in an environment that subjects the part to very high dynamic loads.

One application for the heavy metal part and manufacturing method according to the present application is in a heavy metal alloy warhead application, where small, heavy, and tough fragments are desirable. Similarly, another application would include print warhead or missile structures that are not attainable by subtractive manufacturing methods. Other applications include kinetic energy penetrators, aero-stable flechettes for hypersonic weapons, complicated ballast shapes for constrained areas in missiles or aircraft, armor piercing projectile cores, and radiation shielding. Still other applications include x-ray tubes or machines where additional strength, relative to pure Tungsten, is desirable. The heavy metal part and manufacturing method may also be used in low cost rapid prototyping of tungsten heavy alloy parts.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A heavy metal part comprising:
a plurality of pure metal particles formed of a first metal; and
a metal matrix that is a continuous phase of a mixture of the first metal and a second metal,
wherein the metal particles are a discrete phase within the metal matrix and the heavy metal part is formed by an additive manufacturing process of a powder feedstock comprising the metal particles coated with the second metal.

2. The heavy metal part of claim 1, wherein the heavy metal part is formed of an alloy or metallic composite of the first metal and the second metal.

3. The heavy metal part of claim 1, wherein the second metal has a melting point lower than that of the first metal.

4. The heavy metal part of claim 3, wherein the second metal solders to the first metal.

5. The heavy metal part of claim 1, wherein the additive manufacturing process includes one of direct metal laser sintering, electron beam melting, and micro-induction sintering.

6. The heavy metal part of claim 1, wherein the metal matrix is composed of a greater weight percent of the second metal than the first metal.

7. The heavy metal part of claim 1, wherein the first metal has a solubility in the metal matrix between 30 and 40 percent.

8. The heavy metal part of claim 1, wherein the first metal has a density greater than 16 g/cm³ and a melting point higher than 6000 degrees Fahrenheit.

9. The heavy metal part of claim 1, wherein the first metal is tungsten.

10. The heavy metal part of claim 1, wherein the second metal is nickel.

11. The heavy metal part of claim 1, wherein the metal matrix includes a third metal.

12. The heavy metal part of claim 11, wherein the third metal is cobalt.

13. A method for manufacturing a heavy metal part, the method comprising:
melting a portion of a powder feedstock comprising a plurality of metal particles formed of a first metal that are coated in a second metal, to form a layer, wherein the layer is comprised of a metal matrix that is a continuous phase of a mixture of the first metal and the second metal, and the metal particles are a discrete phase within the metal matrix; and welding the layer to another previously formed layer to grow the heavy metal part.

14. The method of claim 13 further comprising heat treating the heavy metal part to optimize specific material properties including tensile strength and ductility.

15. The method of claim 13 further comprising direct metal laser sintering the layer.

16. The method of claim 13 further comprising electron beam melting the layer.

17. The method of claim 13 further comprising micro-induction sintering the layer.
